(19) United States
(12) Patent Application Publication
(10) Pub. No.: US 2005/0187815 A1
(43) Pub. Date: Aug. 25, 2005

(54) Apparatus and methods for surveying, identifying and rectifying actions, especially anomalies in voting and in the elective process, optionally in real time

(76) Inventor: Kenneth Smukler, Villanova, PA (US)

Correspondence Address: CHARLES N. QUINN;FOX ROTHSCHILD LLP, 2000 MARKET STREET, 10TH FLOOR, PHILADELPHIA, PA, 19103, US

(21) Appl. No.: 10/934,105

(22) Filed: Sep. 3, 2004

Related U.S. Application Data
(63) Continuation-in-part of application No. 10/266,173, filed on Oct. 7, 2002.
(60) Provisional application No. 60/500,818, filed on Sep. 4, 2003.
(60) Provisional application No. 60/532,768, filed on Dec. 22, 2003.

(51) Int. Cl. G06F 17/60

(52) U.S. Cl. 705/12

(57) ABSTRACT

A method for real time processing, addressing and archiving voter complaints includes receiving and recording telephone calls from individual voters experiencing voting difficulties; processing the calls to determine a geographic locale to which each call pertains; optionally, at the election of each individual calling voter, recording a message from the calling voter concerning the difficulties being encountered while attempting to vote; selecting from a database a election official responsible for the polling place within said geographic locale pertaining to the attempt to vote; optionally, connecting the calling voter with the election official to enable direct voice telephone communication between the calling voter and the election official; statistically analyzing in real time all of the calls to determine geographic locales in which voter complaints are of significance; sorting the messages as recorded from the calling voters while attempting to vote according to geographic locale from which the calls originated.

### CROSS-REFERENCE TO RELATED PATENT APPLICATIONS

This patent application is a continuation-in-part under 35 USC 120 of pending U.S. patent application Ser. No. 10/266,173, filed 7 Oct. 2002 and published as U.S. 2004/0068519 on 8 Apr. 2004, the priority of which is claimed and the disclosure of which is hereby incorporated by reference. This patent application additionally claims the benefit of the priority under 35 USC 119 of provisional U.S. patent application Ser. No. 60/500,818, entitled “Voting Anomaly Monitoring, Analysis and Multi-Option Real Time Corrective Methods and Apparatus”, which was filed 4 Sep. 2003, and of provisional U.S. patent application Ser. No. 60/532,768, entitled “Election Tracking Method and Apparatus”, which was filed 22 Dec. 2003, with both of these applications being filed in the of Kenneth Smukler. The disclosures of both of these provisional applications are also hereby incorporated herein by reference.

### FIELD OF THE INVENTION

This invention relates to monitoring, analyzing and correcting problems experienced by voters in local, state and national elections.

### BACKGROUND OF THE INVENTION

In the 2000 presidential election events in the state of Florida showed that problems arising out of voter confusion, intimidation and/or coercion need to be identified in real time and preferably captured in and from the voices of the voters as such problems occur. Claims of voter confusion in Palm Beach and claims of civil rights violations across the state could not be addressed at that time due to the lack of contemporaneously gathered evidence of such confusion, intimidation and civil rights violations.

Persons and organizations endeavoring to address such confusion, intimidation, coercion and/or civil rights violations across Florida were able to do so only after the fact, by searching for aggrieved voters and taking their affidavits. Because this activity took place after the fact and consumed substantial time, in many instances the voter confusion, intimidation, coercion and/or civil right violations could be addressed only in an arguably prospective manner, seeking to eliminate such problems in the future.

### DESCRIPTION OF THE DRAWINGS

FIG. 1 is a schematic block diagram illustrating message flows in the course of practice of the methods of the invention, as facilitated by apparatus of the invention.

FIG. 2 is a schematic diagram of apparatus for practice of the methods of the invention.

### DESCRIPTION OF THE INVENTION

In one of its aspects this invention utilizes digital technology allowing the collection of contemporaneous recordings of messages from voters addressing voting problems, with the collection occurring in real time as the problems arise and the voters report the same. The invention embraces the capability to cover the entire United States preferably with an efficient and cost effective interactive voice response system for collecting, analyzing and addressing, on a real time basis, reported voting complaints and occurrences of voter confusion, intimidation, coercion and even violations of voter civil rights.

In another of its aspects the invention provides a platform and infrastructure for use by political campaigns, political parties, foundations and nonprofit organizations, such as the League of Women Voters in addressing such problems. Such organizations may use the invention, as those organizations encourage their members to vote, by empowering their members with a toll free telephone number to protect their member's votes and to protect the vote and voting rights of others.

In yet another of its aspects the invention, through publication and use of an emergency voter hotline, provides an infrastructure for monitoring activity at polling locations using the voters themselves at those polling locations as monitors. Individual voters are provided with a help line through which voter messages cannot only be recorded and archived to address the problem the individual voter is having; preferably the help line also optionally patches the individual voter through to a designated local hotline and an elected official at the other end of the hotline in order to resolve the individual voter's problem.

In a preferred practice of the invention, voters take a hotline telephone number to the polls. An automated telephone system, preferably an interactive voice response system (herein sometimes referred to as an “IVRS”) is preferably tied to the toll free telephone number and preferably accomplishes (i) identification of problem polling locations and real time across the United States in the case of a national election, (ii) retrieval of individual statements from individual callers detailing the problem the caller is having at the polling location and (iii) patching the individual callers to a local county board of election officers who can presumably address and resolve the voter's problem in a most efficient manner.

In the course of practice of one of the preferable methods of the invention, as voter calls begin to come in to a central call station from around the nation on an election day, a computer connected by a modem to the call processing center tracks the incoming voter call traffic. Each incoming voter call carries a code which allows the computer software to patch that incoming voter call to an appropriate local agent at the polling place or a local official responsible for the polling place at which the calling voter is experiencing a voting problem. This is desirably accomplished by analyzing a zip code provided as a part of the incoming call identifier and linking that zip code through a database correlating zip codes with county board of election officers, to the responsible county election office or official.

In a further aspect of the invention, software preferably permits recording statements made by the voters when placing their incoming calls to report voting problems. These statements are necessarily made by the calling voters at or about the time the calling voter is confronting impediment to voting. These statements, when recorded, can form the basis of the subsequent affidavit or a press conference detailing problems at a particular polling location in a given state or county or municipality.

In a further aspect of the invention computer software preferably analyzes the incoming calls to establish patterns of voters experiencing problems and thereby identifies locales at which voter problems apparently are systemic or epidemic and provides such locale information to local officials or other agents responsible for addressing and solving voter problems at that particular locale.

In one of its aspects this invention further provides for real time processing, addressing and archiving voter complaints involving coercion, intimidation, confusion and/or violation of civil rights, where the method preferably commences with the step of receiving and recording telephone calls from individual voters experiencing voting difficulties such as coercion, intimidation, confusion and/or violation of civil rights. In this aspect of the invention the method preferably proceeds by processing each of the calls to determine the geographic location to which each received call pertains. The method preferably further proceeds optionally, at the election of each individual caller, by recording a message from the caller concerning the coercion, intimidation, confusion and/or violation of civil rights suffered by the caller as the caller has attempted to vote.

The method preferably proceeds by selecting from a database an election official responsible for, or some other agent proximate to, the polling place within the geographic location pertaining to the individual caller who has attempted to vote. The method preferably further proceeds with optionally, at the election of the caller who has attempted to vote, connecting the caller with the responsible election official or the aforementioned agent to enable direct voice telephone communication between the voter experiencing voting difficulties such as coercion, intimidation, confusion and/or violation of civil rights, and the election official or the agent. The method preferably yet further proceeds with preferably statistically analyzing preferably in real time all of the calls to determine geographic locations in which voter complaints of coercion, intimidation, confusion and/or violation of civil rights were of significance.

The method then proceeds with the sorting of the messages as recorded from the callers concerning coercion, intimidation, confusion and/or violation of civil rights being suffered by the callers as the callers have attempted to vote, with the sorting being according to the geographic location to which the messages and the associated calls pertain. The method may optionally proceed to print the messages and use the same to address and correct conditions which lead to voter complaints involving coercion, intimidation, confusion and/or violation of civil rights.

In another of its aspects the invention embraces apparatus for real time processing, addressing and archiving voter complaints involving coercion, intimidation, confusion and/or violation of the civil rights of the voter where the apparatus preferably includes means for receiving and recording telephone calls from individual voters experiencing voting difficulties such as coercion, intimidation, confusion and/or violation of their civil rights, means for processing each of said calls in order to determine the geographic locale to which each received call pertains, means for optionally, at the election of each individual voter-caller, recording a message from the voter-caller concerning the coercion, intimidation, confusion and/or violation of the voter's civil rights or other problem being suffered by the voter-caller as the voter-caller has attempted to vote, means for selecting from a database an election official responsible for, or some other agent proximate to, the polling place within the geographic locale pertaining to the voter-caller attempting to vote, means for optionally, at the election of the voter-caller, connecting the caller with the election official or the agent to enable direct voice telephone communication between the voter-caller experiencing voting difficulties such as coercion, intimidation, confusion and/or violation of the voter's civil rights or other problem and the election official or the agent, means for statistically analyzing, preferably in real time, all of the calls to determine the geographic locales in which voter complaints of coercion, intimidation, confusion and/or violation of voter's civil rights are of significance and means for sorting the messages as recorded from the voter-callers concerning coercion, intimidation, confusion and/or violation of the voter's civil rights being suffered by the voter-callers as the voter-callers have intended to vote, according to a geographic locale to which the messages and the associated calls pertain. Optionally the apparatus may further include means for printing a message in order to address and correct conditions which lead to voter complaints involving coercion, intimidation, confusion and/or violation of the voter's civil rights or other problems.

The invention provides the first data rooted in the contemporaneous recordings of voices of voters experiencing voting problems. The data, in the form of the voters call-in messages, is both time stamped and geographically identified as the data enters the database. As a result, the database, when complete, allows the user to provide an empirical analysis of voter confusion, intimidation, coercion or even civil rights violations suffered by the voter. Reports produced using the method and the data collected thereby provide factual analyses of what occurred on election day, with much, much higher reliability than techniques, methods and apparatus known heretofore.

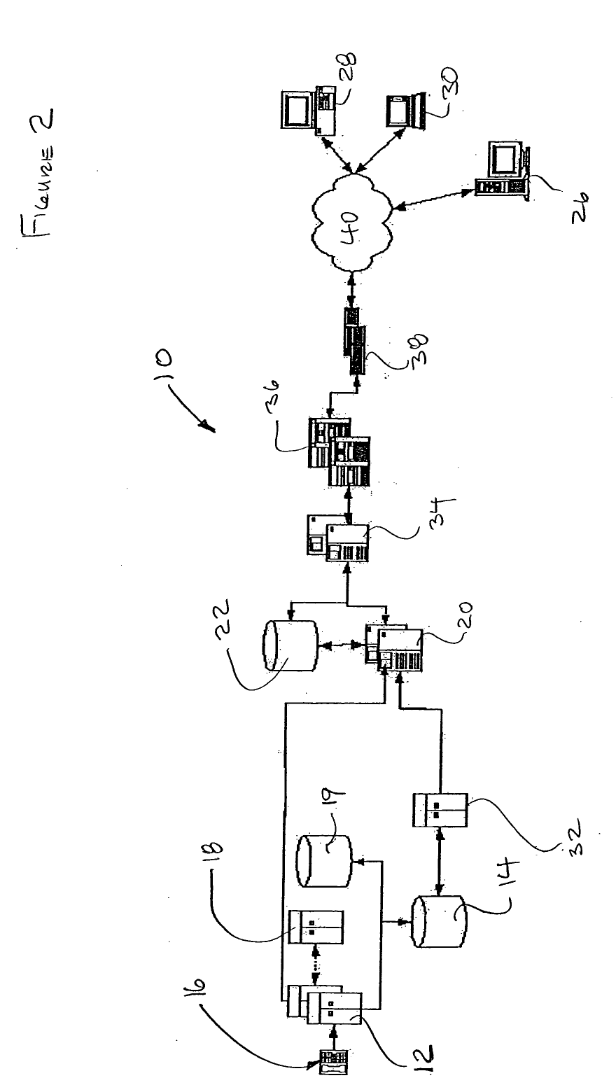

Referring to FIG. 2, apparatus for voting anomaly monitoring, analysis and multi-option real time correction is illustrated generally schematically and designated generally 10. Apparatus 10 preferably has connected thereto at least one voter telephone, a single one of which is illustrated schematically and designated 16. It is to be understood that hundreds of thousands, if not millions, of voter telephones may be connected, at one time or another, to the remainder of apparatus 10.

Telephone lines from exemplary voter telephone 16 are preferably connected to a primary interactive voice response system designated generally 12 in FIG. 2.

While telephone lines have been depicted running from telephone 16 to the primary interactive voice response system designated generally 12 in FIG. 2, it is to be understood that cellular telephones without any hard wired connection to the primary interactive voice response system preferably are desirably used in the practice of this invention.

A disk storage device 14 preferably serves as the primary storage for voter telephone messages and preferably is connected to the primary interactive voice response system 12 as illustrated in FIG. 2. The line connecting primary interactive voice response system 12 with primary voter telephone message disk storage device 14 is illustrated in FIG. 2 but is not numbered to enhance drawing clarity.

Also preferably connected to primary interactive voice response system 12 is a redundant, backup interactive voice response system designated 18. A backup disk storage device for the primary voter telephone messages is designated 19. A scanner 32 preferably checks for data periodically and preferably updates the backup function in order that data is not lost in the event of failure of a primary component.

A server 20 preferably provides computing power to process the various telephone caller messages, to control and generate replies to the appropriate recorded messages, to make the zip code entry correlations and preferably otherwise run the system. A server disk storage device 22 is connected to server 20 and preferably provides storage as needed by server 20.

A second server 34 preferably processes messages on a personalized basis where a personalized message is to be provided back to the voter-caller. Personalized message server 34 is connected to a number of proxy servers 36 which preferably operate under the control of server 34. Output from proxy servers 36 preferably goes through routers 38 to the Internet, which is designated generally 40.

A system administrator terminal 26, of which there may be more than one, is preferably connected to the remaining components of the system, preferably via the Internet, so that the system administrator need not be at the same locale as the remainder of the system. User terminals 28 and 30 are also preferably connected to the Internet so that the users need not be at the same locale as the hardware on which the system substantially operates. User terminals include preferably both ordinary user terminals 28 and super user terminals 30. Ordinary user terminals 28 only permit the user to monitor the operation of the system; super user terminals 30 allow an operator to interact with the system and the messages received, for example by speaking directly with a voter making an incoming call.

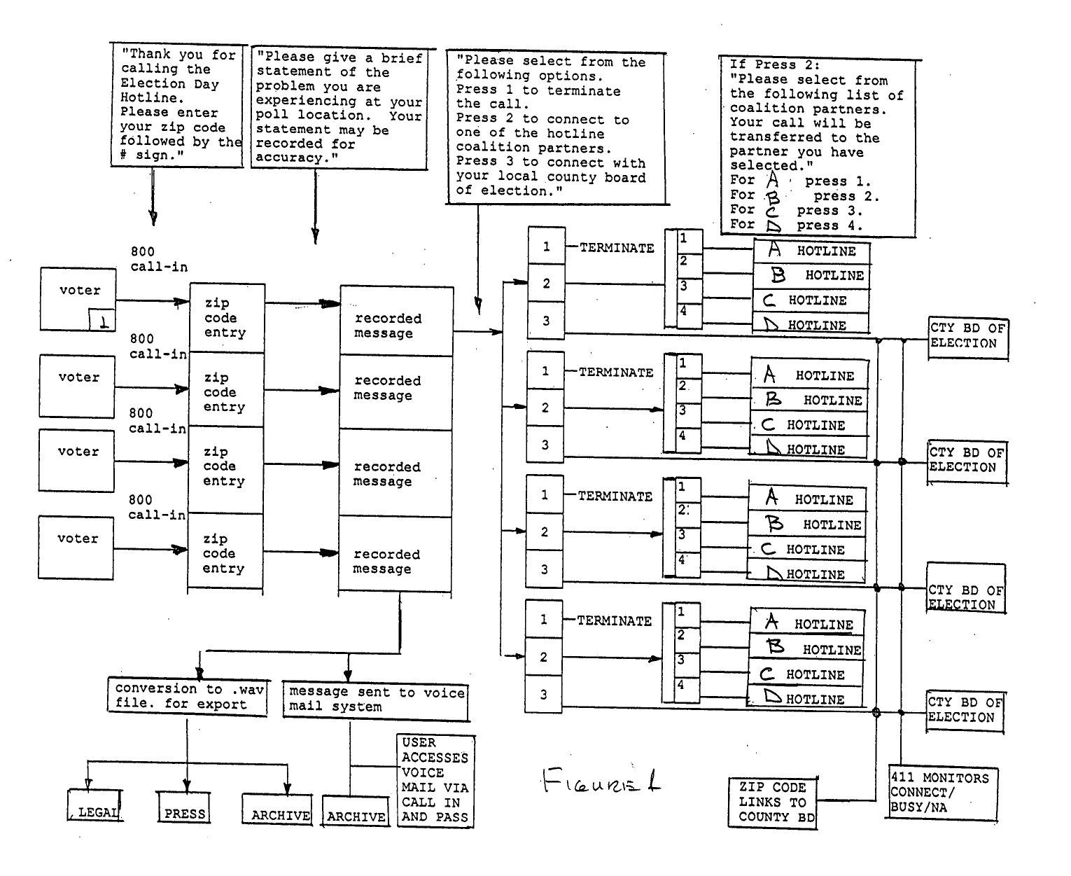

Referring to FIG. 1 illustrating flow of messages and information in the system, a voter experiencing voting difficulties and making an incoming call to the system is denoted by the box enclosing the legend “voter” and numbered “1” in FIG. 1. This voter 1 has preferably previously received an 800 number via by which he/she may call, toll-free, the voting anomaly monitoring, analysis and multi-option real time correction center as depicted in FIGS. 1 and 2.

When voter 1 makes his/her toll-free, 800 line call, he or she receives a greeting such as indicated in the box in FIG. 1 above the legend “800 calling” where the greeting is “Thank you for calling the Election Day Hotline. Please enter your zip code followed by the pound sign.” Of course, these greetings are exemplary; the invention is not limited to the greetings set forth herein.

Once voter 1 enters his or her zip code followed by the pound sign, the system preferably accesses a zip code directory in order to identify the locale from which voter 1 is presumably calling, which is the locale at which voter 1 should be voting. Once this is done, the system provides a second reply to voter 1 in the form of a request. An exemplary one of these requests appears as the second box from the left in FIG. 1 along the top of the Figure. Specifically, voter 1 now hears a request such as “Please give a brief statement of the problem you are experiencing at your poll location. Your statement may be recorded for accuracy.”

In response to this request, voter 1 then makes a statement via telephone and the statement is recorded as indicated by the box labeled “recorded message” in FIG. 1. Once the system senses that the statement has concluded, the system provides a series of prompts to voter 1. Exemplary ones of these prompts appear in the third box from the left along the top of FIG. 1.

The message voter 1 hears with the prompts may be as follows: “Please select from the following options. Press 1 to terminate the call. Press 2 to connect to one of the hotline coalition partners. Press 3 to connect with your local county board of elections.”

Voter 1 then presses the appropriate button on voter 1's telephone. If button 1 is pushed, the call is terminated but the recorded message from voter 1 is saved as is the zip code information indicating from where voter 1 was calling to leave the recorded message.

All of the recorded messages are periodically sent to a voicemail system as indicated at the bottom of FIG. 1, where the recorded messages are archived. A user of the system, and in this regard a “user” is to be distinguished from a “voter”, may access the voter messages which have been archived by the voicemail system and use those messages for various purposes.

As further indicated at the bottom of FIG. 1, in the bottom left hand corner, the recorded messages are also converted to wave file formats for export to appropriate archive facilities, to the press or to legal resources in the event the recorded messages are needed, for example in connection with legal action addressing the difficulties voter 1 experienced in attempting to vote in the election.

Returning to the subject of the recorded messages, if voter 1 pressed the number two on his or her telephone, voter 1 would be connected to one of the hotline coalition partners. The next prompt voter 1 would hear would allow voter 1 to select a given organization among the hotline coalition partners, to whom voter 1 may directly voice voter 1's difficulties in voting and proceed to participate in a telephone discussion with a representative of that coalition partner. If voter 1 presses the number 2 on voter 1's telephone, voter 1 then hears the following prompt: “Please select from the following list of coalition partners. Your call will be transferred to the partner you have selected. For A press 1. For B press 2. For C press 3. For D press 4.” Once voter 1 selects and presses the relevant key on voter 1's telephone, voter 1 is connected to a representative of coalition partner A, B, C or D, according to the selection voter 1 has made. Voter 1 may then converse with the representative of the selected coalition partner and then further address voter 1's difficulties in voting.

Returning to the position of the recorded messages in the block diagram of FIG. 1, if voter 1 had pressed 3 in response to the prompt “Please select from the following options . . . ”, voter 1 would immediately be connected directly to the county board of elections or other responsible elected or appointed government official having jurisdiction over and responsibility for voting activity at voter 1's polling place. Having made that connection, voter 1 may then voice his or her concerns regarding the difficulties he or she has experienced in voting directly to the county board of elections or other responsible official to which the system has connected voter 1.

The system administrator monitors the entire operation of the system as indicated by the box at the lower right hand corner of FIG. 1. Additionally, as indicated by the box labeled “zip code links to county board” the system preferably compiles data and statistics as to voter complaint by zip code in order to provide, on a real time basis, identification of those zip codes throughout the country in which significant percentages of voters are encountering voter difficulty. From this data, which is collected on a real time basis, one of the users of the system, for example one of the coalition partners, can preferably take action such as by contacting the relevant responsible local official or officials in those zip code areas where significant numbers of voters are experiencing voting difficulties.

1) A method for real time processing, addressing and archiving voter complaints involving coercion, intimidation, confusion and/or violation of civil rights, comprising:
a) receiving and recording telephone calls from individual voters experiencing voting difficulties such as coercion, intimidation, confusion and/or violation of civil rights;
b) processing each of said calls to determine a geographic locale to which each said call pertains;
c) optionally, at the election of each individual caller, recording a message from the caller concerning the coercion, intimidation, confusion and/or violation of civil rights being suffered by the caller as the caller has attempted to vote;
d) selecting from a database a election official responsible for, or some other agent proximate to, the polling place within said geographic locale pertaining to the caller attempting to vote;
e) optionally, at the election of the caller, connecting the caller with said election official or said agent to enable direct voice telephone communication between said voter experiencing voting difficulties such as coercion, intimidation, confusion and/or violation of civil rights, and said election official or said agent;
f) statistically analyzing in real time all of said calls to determine geographic locales in which voter complaints of coercion, intimidation, confusion and/or violation of civil rights are of significance;
g) sorting said messages as recorded from the callers concerning coercion, intimidation, confusion and/or violation of civil rights being suffered by the callers as the callers have attempted to vote, according to a geographic locale to which said messages and the associated calls pertain.

2) The method of claim 1 further comprising printing said messages and using the same to address and correct conditions which led to voter complaints involving coercion, intimidation, confusion and/or violation of civil rights.

3) Apparatus for real time processing, addressing and archiving voter complaints involving coercion, intimidation, confusion and/or violation of civil rights, comprising:
a) means for receiving and recording telephone calls from individual voters experiencing voting difficulties such as coercion, intimidation, confusion and/or violation of civil rights;
b) means for processing each of said calls to determine a geographic locale to which each said call pertains;
c) means for optionally, at the election of each individual caller, recording a message from the caller concerning the coercion, intimidation, confusion and/or violation of civil rights being suffered by the caller as the caller has attempted to vote;
d) means for selecting from a database a election official responsible for, or some other agent proximate to, the polling place within said geographic locale pertaining to the caller attempting to vote;
e) means for optionally, at the election of the caller, connecting the caller with said election official or said agent to enable direct voice telephone communication between said voter experiencing voting difficulties such as coercion, intimidation, confusion and/or violation of civil rights, and said election official or said agent;
f) means for statistically analyzing in real time all of said calls to determine geographic locales in which voter complaints of coercion, intimidation, confusion and/or violation of civil rights are of significance; and
g) means for sorting said messages as recorded from the callers concerning coercion, intimidation, confusion and/or violation of civil rights being suffered by the callers as the callers have attempted to vote, according to a geographic locale to which said messages and the associated calls pertain.

4) Apparatus of claim 3 further comprising means for printing said messages in order to address and correct conditions which led to voter complaints involving coercion, intimidation, confusion and/or violation of civil rights.
